(19) United States
(12) Patent Application Publication
(10) Pub. No.: US 2017/0147588 A1
(43) Pub. Date: May 25, 2017

(54) SYSTEM AND METHOD FOR CENTRALIZED DOCUMENT CAPTURE, MANAGEMENT AND RETENTION

(71) Applicant: ECO-MAIL DEVELOPMENT LLC, Mt. Kisco, NY (US)

(72) Inventors: Jay Maller, Katonah, NY (US); Bikram Chaudri, New York, NY (US)

(21) Appl. No.: 14/946,297

(22) Filed: Nov. 19, 2015

(51) Int. Cl. G06F 17/30

(52) U.S. Cl. CPC G06F 17/30085; G06F 17/30073; G06F 17/30011

(57) ABSTRACT

Retention policies are processed and implemented for physical and electronic content. An image file generated from a physical copy of content is both processed and structured to obtain and identify at least a category. Minimum document retention periods are obtained and identified for use with the physical copy of the content and the electronic copy. A location is identified to retain the physical copy with a plurality of other respective documents that each have a respective document retention period, and the physical copy is scheduled to be retained for no shorter than the longest document retention period associated with the plurality of other respective documents. Action to be taken in connection with at least one of the physical copy of the content and the electronic copy of the content is monitored. The physical copy and the electronic copy are retained in accordance with the compliance instructions. Systems and methods are disclosed.

### FIELD OF THE INVENTION

The present invention regards improvements in commercial and domestic mail distribution and, more particularly, to a structured, secure and controlled electronic document distribution system to supplant at least a significant portion of existing physical mail distribution systems.

### BACKGROUND OF THE INVENTION

Distribution of commercial mail has traditionally centered around the movement of paper. Paper needed to be delivered to the mail provider as raw material in the printing of documents. Paper also needed to be moved from the point of printing to the United States Postal Service (USPS) and within the USPS to a recipient destination. Even after delivery to the recipient, paper must be managed in order to reach the intended recipient or otherwise undergo an organization's processing requirements before ultimately being forwarded to long-term storage or disposal. These processes were necessary and reasonably efficient in a world where digital communication did not exist; however, the point of the process was never to move paper, but rather to move information. In today's electronic world it is entirely possible to reengineer the process to curtail paper movement within an enterprise and remove the steps and costs associated with movement of physical mail. Moreover, email communications and other digital messaging systems, including systems implemented with electronic user interfaces, have largely usurped physical mail.

Despite the vast of amount of email transacted each day, email has not completely replaced mail. Mail that is received in physical form continues to have importance. Unfortunately, physical mail continues to pose various administrative and handling challenges. For example, intended recipients of physical mail are not always apparent. Companies may have some commonly-named employees, such as John Smith, and locating the correct John Smith can consume resources and time Likewise, physical mail may be addressed to a group rather than an individual,—another version of a “commonly named” destination, which also can interfere with the mail being received by the proper or intended recipient. Moreover, physical mail can be incorrectly addressed.

Physical mail often comes in many different forms and can include various kinds of content. Companies and/or individuals often have respective retention rules in place, including for email and physical mail alike, often depending upon the particular content. Standard class mail for example may have no retention rules, while first-class mail, which can contain important legal documents, may have to be retained for up to several years from the date of receipt. Moreover, physical mail often contains documents that require proper and timely responses for compliance, such as a form that needs to be executed and returned, or an answer to a consumer complaint that is required to diffuse a volatile situation. Moreover, retention policies may need to be compliant with local and federal guidelines and laws. Thus, proper handling of physical mail in conjunction with email, particularly in a commercial environment, remains an important and often frustrating concern. The present invention addresses these and other needs in the art.

### SUMMARY OF THE INVENTION

In accordance with a broad aspect of the invention, systems and methods are provided for processing and implementing retention policies for physical and digital copies of content in accordance with compliance instructions. In one or more implementations, a determination module comprising code is operative within at least one processor to process an image file generated from the physical copy of the content to obtain and identify at least a category of the content. Further, respective minimum document retention periods are obtained and identified for use with the physical copy of the content and the digital copy of the content. The determination module is further operative to identify a location to retain the physical copy with a plurality of other respective documents that each have a respective document retention period, and the physical copy is scheduled to be retained for no shorter than the longest document retention period associated with the plurality of other respective documents. Moreover, an auditing module is provided that comprises code that is operative within the at least one processor to monitor action taken in connection with at least one of the physical copy of the content and the digital copy of the content. The auditing module is further provided to identify that the physical copy of the content and the digital copy are retained in accordance with the compliance instructions.

In accordance with a further aspect of the invention, a messaging module comprising code is provided that is operative within the at least one processor to generate and transmit a message associated with retention rules associated at least one of the physical copy and the digital copy. The messaging module is further operative to transmit a message to at least one person, wherein the message represents imminent destruction of at least one of the physical copy and the digital copy. The messaging module is further operative to transmit the message representing imminent destruction based on the monitored action.

In accordance with a further aspect of the invention, a tagging module comprising code is provided that is operative within the at least one processor and in connection with the auditing module to tag activity taken in connection with at least one of the physical copy and the digital copy. When the activity represents user interaction with the physical copy, the activity can include at least one of accessing, reading, modifying and destroying the physical copy. When the activity represents user interaction with the digital copy, the activity can include at least one of accessing, opening, reading, modifying and destroying the digital copy. The tagging module is operative to generate and manage a tag list that includes the tagged activity.

In yet a further aspect of the invention, a logging module creates a log of any activities of the types described above across all of the documents processed by the system, including both physical and electronic copies.

In accordance with a further aspect of the invention, the physical copy of the content is received by postal delivery, and the determination module is further operative to automatically obtain and identify using a processor configured by code at least one of a sender and recipient of the physical content. Still another aspect of the invention has at least one of the respective document retention periods of the physical copy and the digital copy is established by the determination module based on regulatory compliance.

These and other aspects, features and arrangements can be further appreciated from the accompanying description and corresponding drawing figures.

### BRIEF DESCRIPTION OF THE DRAWING FIGURES

FIG. 1 illustrates an electronic distribution network in accordance with an implementation of the present invention.

FIG. 2 shows a simplified functional block diagram of the electronic distribution network identified in FIG. 1.

FIG. 3 is a simplified block diagram of an electronic provider station, in accordance with an implementation of the present invention.

FIG. 4 illustrates a simplified block diagram of a Reference Data Station, in accordance with an implementation.

FIG. 5 shows a simplified block diagram of an electronic eDoc Transaction Management Station, in accordance with an implementation of the present invention.

FIG. 6 illustrates certain components of the EM Subscriber station, in accordance with an implementation.

FIGS. 7A-7C describe steps associated with physical and electronic mail processing in accordance with an example implementation.

FIG. 8 is a table illustrating a plurality of selectable documents that correspond to a respective individual.

FIG. 9 is a block diagram of an example implementation of the present invention and illustrating document retention and storage of physical documents.

### DETAILED DESCRIPTION OF CERTAIN EMBODIMENTS

By way of overview and introduction, exemplary embodiments are described, which implements several aspects of the invention. The invention is capable of other implementations than as embodied in the particular embodiments illustrated herein. The embodiments described herein, however, provide an expedient for enabling a person of ordinary skill in the art to make and use the invention.

The present application provides for management and retention of physical documents (“PD”) as well as for the capture, management and retention of electronic documents that are based on or otherwise respectively replicate the physical documents (hereinafter referred to, generally, as digital reproductions of physical documents (“DRPD”)). In addition to DRPD, various digital documents (“DD”) can be managed, which may be copies of DRPD, correspondences regarding DRPD and/or PD, metadata or other digital files that are associated with DRPD and/or PD (e.g., representing user activity associated therewith). The terms PD, DRPD and DD can refer to multiple and/or individual documents, unless explicitly set forth herein. For example, PD, DRPD and DD can refer to a single instance (e.g., a single physical document or a single digital document), or PD, DRPD and DD can refer to a plurality of instances (e.g., a plurality of physical documents or a plurality of digital documents). In one or more implementations, DRPD can be the same as DD except, in the system described, the DRPD have associated PD. DD and DRPD can exist in multiple copies or may have multiple links to the same distributable copies. Thus, a DRPD can refer to a digitally reproduced physical document because such DRPD owes its origin to a respective PD. Otherwise, DRPD and DD may be indistinguishable.

In the following description, references to a “user” is not meant to be limited to a individual person or the same individual. As used herein, a “user” can include any one or more users who may be involved single task or doing the same task. Each reference to a user, herein, can be to the same user, to a different user, the same group of users or a different group of users. Similarly, unless explicitly noted, use of the modifier “a” can refer to a single instance (e.g., a single document) or a plurality of instances (e.g., more than one document).

The system and method described herein enable a coordination of retention rules across both PD and DRPD to better ensure that document retention across both media are synchronized. PD and/or DRPD may be destroyed and thereby removed from company files, for example, in accordance with applicable retention rules for each respective document type, which are synchronized in accordance with the teachings herein.In certain implementations, features of the present application can be integrated with or included in secure content production and distribution systems and methods. For example, the present application can be configured in one or more modules that integrate with systems that provide electronic content, such as documents, in a structured and secured environment. Such systems are usable to replace or otherwise augment existing physical mail and electronic mail (e.g., “email”) distribution systems. Examples of such systems are described in greater detail in, for example, co-pending and commonly assigned U.S. Non-Provisional patent application Ser. No. 14/530,511, filed Oct. 31, 2014, and U.S. Non-Provisional patent application Ser. No. 14/318,074, filed Jun. 27, 2014, each of which are hereby incorporated by reference in their respective entities. The present application provides a suite of services in support of users, including with regard to production, distribution, management and auditing of PD and DD.

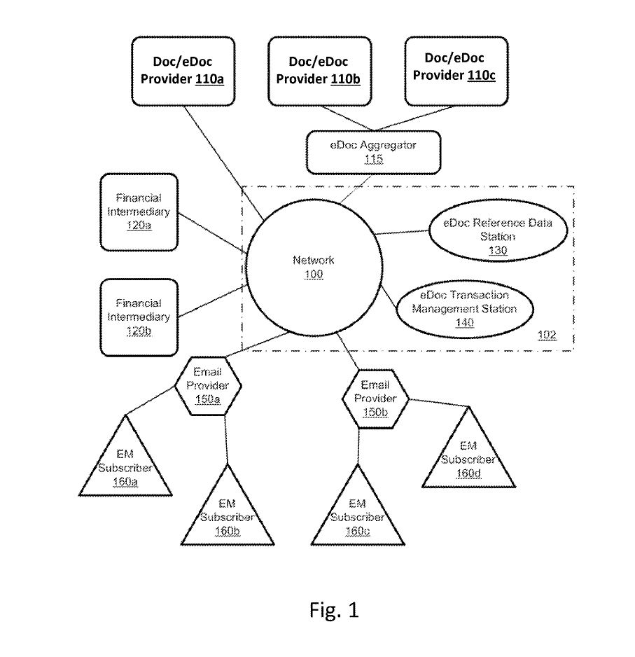

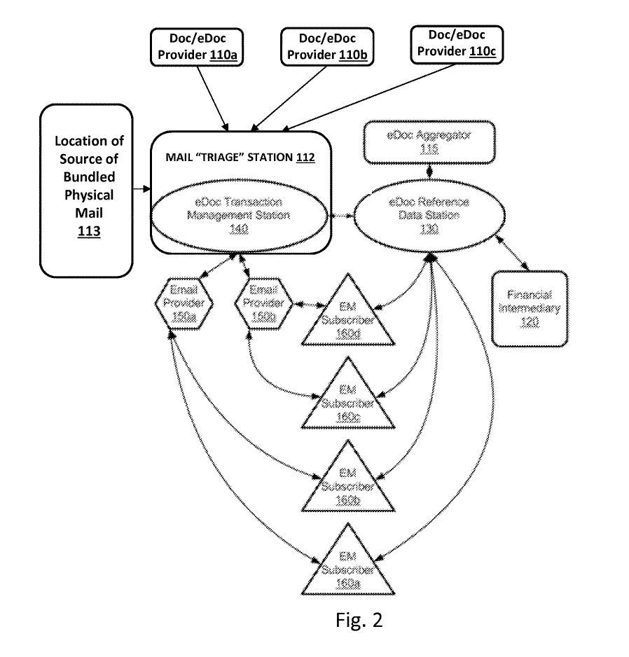

The present application provides for improved capture, management and retention of PD (e.g., mail) that is received, for example, by a company. Referring to FIGS. 1 and 2, in one or more implementations, physical mail that is sent to one or more locations (e.g., postal addresses) is forwarded to a central processing location, which includes a mail triage station 112 for handling. The mail triage station 112 can be used as a receiving and staging area for all physical mail that is received by an organization. Alternatively, the mail triage station 112 can be employed to receive physical mail that cannot be readily identified or that has an addressee that is not readily identifiable. In yet another instance, mail triage station 112 receives all “process mail,” which can include mail addressed to P.O. Boxes or other locations. Forwarding of such mail to a single preferred location (e.g., mail triage station 112) can be implemented by a service offered by the United States Postal Service (“USPS”) or other third party. For example, any mail that is addressed to a respective company and includes a P.O. Box (as opposed to a physical address) can be automatically forwarded by the USPS to the mail triage station 112.

The mail triage station 112 can, in one or more implementations, incorporate a transaction management station “TMS” 140 configured to capture content, validate, secure, transmit and track the content as it moves through the EM system as a structured electronic file that can cooperate with a system 102 (FIG. 1) to implement its distribution, management, and auditing functionality, such as the Eco-Mail system which is more completely described in the aforementioned patent documents which have been incorporated by reference. The mail triage station 112 can also be configured to include modules, stations and machines (any of which can be located around the world) and to access data storage that is local to the machines or stored remotely, such as in a cloud environment. Thus, the example representation of eDoc Transaction Management Station 140 being illustrated within the mail “triage” station 112 is symbolic to represent one of control and access, and not meant to imply any physical and/or geographical limitation.

### Physical Document Capture and Conversion Into Structured Electronic Files

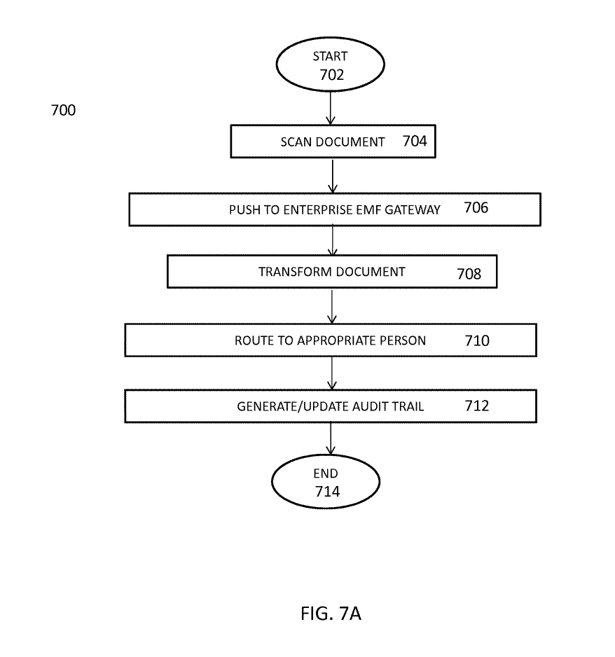

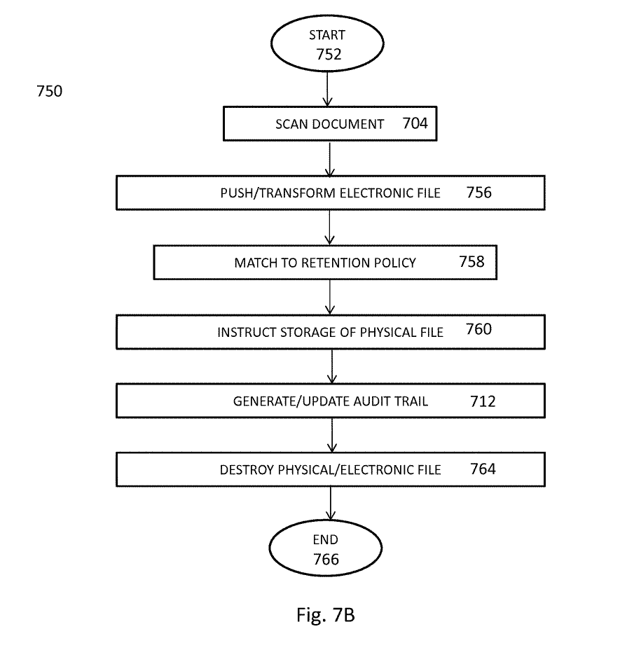

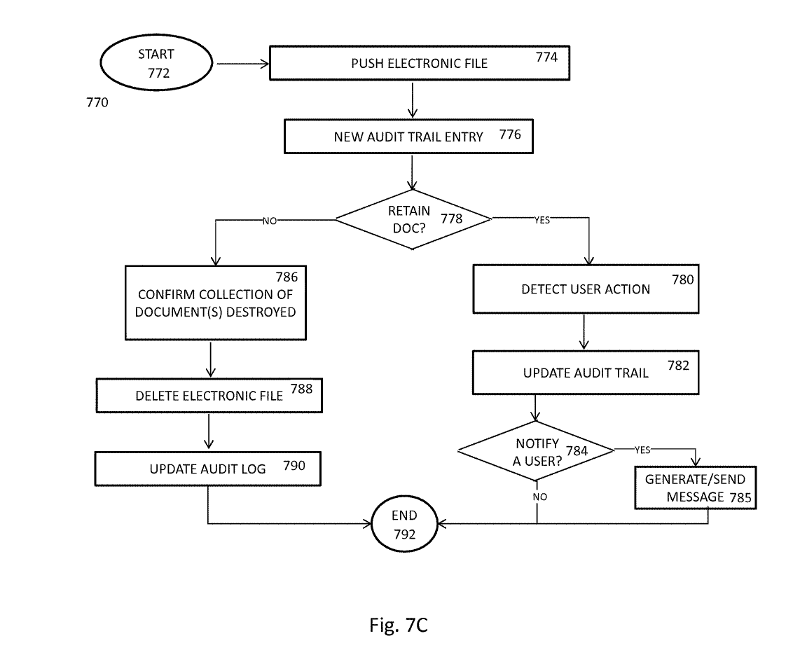

Turning now to FIGS. 7A-7C, flow diagrams are described showing routines that illustrate broad aspects of one or more implementations disclosed herein. It should be appreciated that several of the logical operations described herein are implemented (1) as a sequence of computer implemented acts or program modules running on computing devices and/or (2) as interconnected machine logic circuits or circuit modules within a computing device. The implementation is a matter of choice and can be (though not necessarily) dependent on the requirements of the device (e.g., size, mobility, energy, consumption, performance, etc.). Moreover, although the example routines illustrated in the flow diagrams appear to be sequential and/or synchronous, the invention is not so limited. One skilled in the art will recognize that operations provided herein may occur in an asynchronous and/or non-sequential fashion. Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

FIG. 7A is high-level flowchart illustrating steps 700 associated with physical and electronic mail processing in accordance with an example implementation. At step 702, the process starts with receipt of physical mail. Thereafter, one or more PD included in the mail is scanned (step 704). This can include using a charge-coupled device array, one or more image sensors or other suitable hardware to generate an image or other electronic file of the document. In one or more implementations, the scanning process of physical mail items can accommodate hundreds of pages per minute, and processing rules are defined and implemented to analyze, statistically characterize and forward the scanned documents, as well-understood in the art, into the system, thereby requiring little if any additional (human) intervention. Moreover, scanning processes for mail can occur during the time when a user is interacting with a graphical user interface, such as while a user responds to prompts for information associated with a previously scanned piece of mail. In this way, a streamlined process is provided in which a person is reviewing and processing material while scanning of a next piece or numerous next pieces of mail can occur simultaneously. After an image or other electronic file is produced that represents the contents of physical mail, the image or electronic file is “pushed” to an enterprise mail gateway (step 706). This can include, for instance, forwarding the image file to another server or server module.

The image file is processed, for example, by a determination module (prior to or after being pushed to the enterprise mail gateway) which converts the image file to a different file type and associates (“wraps”) additional information with the image file (step 708). For example, one or more optical character recognition (“OCR”) processes can occur to convert the image file into machine-encoded text. In one implementation, the image file is a bitmap containing letters in a pixel form, and vector data are generated representing the pixel form. The vector data are compared to the shapes of letters, and machine-encoded text is provided in response to the comparison. Other forms of OCR processing are envisioned and supported.

In addition, the name, address and contact information of a sending party identified on the envelope that accompanied the scanned document or the scanned document itself is determined from the scanned physical mail and meta data representing the determined information and is associated with the image file as part of the transformation at step 708. Capturing information associated with mail and providing enhanced data records associated with the mail contribute to the disclosed system implanting an organized workflow for handling scanned-document related processing results which can otherwise appear to be random or otherwise unknown variables. Other metadata extracted from the scan includes the intended recipient, and a category of the mail (e.g., standard class mail, personal mail, group addresses, and/or process mail—mail addressed to a P.O. Box).

In addition to generating machine-encoded text, and wrapping additional information with the file, one or more modules can operate to provide various functionality, such as content management, document management, business processes, records management, user activity audits and search functionality. In some implementations, such modules include one or more coordinated devices (e.g., computers) and/or other resources (e.g., active directory lookups, and more particularly, LDAP lookups). The modules operate to identify and access information associated with scanned information.

As noted herein, providing mail content to appropriate recipients in a commercial setting can consume large amounts of resources, particularly for physical mail items that are misaddressed, generally addressed to a group (e.g., “law department”) or addressed to someone who shares a name with others, e.g., “John Smith.” At step 710, the scanned copy that is been pushed to the enterprise mail gateway is routed to one or more appropriate persons. This can include accessing, via TMS140, data logs, directories and/or computer accessible databases that can be remotely located on a plurality of networks. Information stored in the database(s) can represent individuals who are associated with broad categories, such as respective employment positions, departments and titles. Such data associations are useful to identify and appropriately route the scanned copy that has been pushed to the enterprise mail gateway to individuals who may not have been specifically addressed in the physical mail. For example, if a letter has been addressed simply to the “law department” of a company, the physical letter is processed, its contents are categorized and identified as requiring attention by legal staff. A senior attorney in the company's law department is listed in a database directory as the suitable recipient on behalf of the law department to receive the contents. The senior attorney is, thereafter, provided access to the content of a particular letter by routing the scanned copy to that person in accordance with the data associations known to the TMS. Continuing with this example, over time the senior attorney assigned to the case is replaced and a new person takes over the position. The database directory is updated to reflect the change, and as new physical mail that is addressed to the law department is received and processed, the content associated with each new mail is provided to the new person. Thus, the present application includes functionality, such as via TMS 140, to access core referential data associated with employees and others affiliated with a company or other organization, and mail content can be automatically routed to individuals without human intervention. This is possible by the system 102, notwithstanding the physical mail being addressed incorrectly, addressed to one of several individuals having the same name, addressed to a department or group, or addressed in some other way that does not clearly identify the correct, individual recipient.

In addition to capturing the routing event concerning the routing of transformed DD to appropriate personnel, an audit module determines and tracks when the scanned document is acted on, such as when users open the file and review its contents. At step 712, an audit trail that represents a history of such user actions is generated and/or updated (step 712). A more detailed discussion regarding generating and maintaining an audit trail is described below, with reference to FIG. 7C. Thereafter, the process ends (step 714).

Thus, and in accordance with one or more example implementations, individual items of mail are received by the mail triage station 112, which may be addressed to P.O. Boxes, departments, individuals and/or may be forwarded from the USPS or another source. The mail is opened and scanned and an electronic document (“eDoc”) is generated and transformed to comprise a digital file that includes identification and category metadata, as described above, which is stored for distribution and tracking purposes. Thereafter, one or more data entry selections can be made by a user using a computing device and in response to prompts provided in a graphical user interface or programmatically without user intervention, and utilized to initiate document retention management and/or mail handling functionality. Thus, in some cases and in lieu of manual data entry, automatic processing can occur to populate data entry options after a user has provided some basic information using the interface. For example, a piece of mail can be identified and categorized broadly as standard class mail, personal mail, legal document, money (e.g., checks) or the like as a result of automated processing. Moreover, other descriptive information can be obtained, such as whether the content of the mail relates to a recently deceased person. In such example, TMS 140 can be programmed to make a determination that the particular mail item is a death certificate. Accordingly, TMS 140 can be configured to determine and manage the contents of each particular mail item, or flag a subset of scanned items for manual intervention.

### Document Retention

In addition to capturing and managing documents and information associated therewith, the present inventions provides modules for managing and enforcing rules associated with PD and DRPD retention. Rules for regulatory compliance associated with document retention can be defined for particular document types, and stored in one or more databases for future reference and processing. For example, physical financial record documents may have a minimum document retention period of two years, while physical death certificates may have a minimum retention period of six months. DD (e.g., eDocs) of the same financial and death certificates, on the other hand, may have different (e.g., shorter) document retention requirements. For example, electronic financial records may have a one-year minimum retention period (as opposed to two years for the PD), and electronic death certificates may have a three-month minimum retention period (as opposed to six months for the PD).

One or more memory portions store instructions to ensure, for example, regulatory (and other) compliance for respective PD and DD and document types, and the rules are implemented accordingly. Compliance instructions, at least in part, monitor and track information associated with document handling, including identifying who touched a mail document, identifying when the document was last accessed by someone, identifying the location where the document is stored, and identifying if and when the document was destroyed. Tracking such information increases accountability and compliance with regulatory rules associated with document retention. In one or more implementations, options can also be provided for sending and receiving encrypted or unencrypted content, and/or a link (e.g., a hyperlink) to such content, to further ensure that particular documents are available only to authorized individuals.

FIG. 7B is a flowchart illustrating steps 750 associated with physical and electronic mail processing, and describes steps associated with file retention and management of PD and DD in accordance with an example implementation. At step 752, the process starts. Physical mail is received and at least one sheet of paper is scanned (step 704). At step 756, an electronic file is generated that contains information associated with the scanned document and is pushed to the enterprise mail gateway and transformed, such as shown and described above in connection with steps 706-710 (FIG. 7A). At step 758, information associated with the scanned document is used to match a respective retention policy to each particular scanned document. A database that stores electronic information associated with retention rules for categories of PD and/or DD is accessed. The respective category associated with the scanned document is used as a basis to match the corresponding retention policy. As previously stated, the matched retention policy governs, among other things, how long the document must be retained before its destruction, optimally in regard to each of its physical and electronic formats.

After the scanned document is matched to its retention policy, storage of the PD and the DD is instructed to proceed (step 760). For example, a plurality of boxes are identified for documents that are being retained for a particular time periods (e.g., 30 days, 90 days, 120 days, 6 months, one year, etc.), and instructions are provided for storing the respective document in a box that retains documents for no shorter than the longest document retention period associated with the plurality of other respective documents in the respective box. If the retention period for the PD associated with the scanned document is nine months, for example, then the PD will be stored in an available box that has a retention period no less than required by the retention policy, such as having a one-year retention.

Continuing with reference to steps 750 in FIG. 7B, at step 712 an audit trail that represents a history of user actions in connection with the PD and/or DD is generated and/or updated, as briefly described previously. A more detailed discussion regarding generating and maintaining an audit trail is described below with reference to FIG. 7C. Thereafter and in accordance with the respective file retention policy associated with the document, the document and possibly the corresponding electronic file is destroyed (step 764). Thereafter, the process ends (step 766).

The present application can include various mechanisms to increase accuracy, such as to preclude destruction of a document prematurely. One or modules can be provided that cross-reference information, such as dates, from different sources and to detect inconsistencies based on the step of cross-referencing. For example, a date of retention is established as a function of information entered in a data entry form. Alternatively, the date of retention is established by an automated (e.g., scanning) process in which information is automatically detected and/or calculated. In order to confirm the accuracy of the entered/established retention date, an alternative source of information can be referenced automatically and compared to the entered/established date. For example, one or more of: a date written in a letter; a postal date stamp on an envelope; a date identified as to when an item was received; a date identified as to when an item was processed is compared to the entered/established retention date. A date checking module can be employed to execute or operate on a computing device to cross-reference the respective data sources and identify and/or correct ambiguities or errors, such as attributed to a scanning error (e.g., 1/7/2015, 1/1/2015, 7/7/2015 or the like), a data entry error, and a date formatting inconsistency (e.g., month/date/year vs. date/month/year). Instructions can be executed that resolve data errors and/or inconsistencies by automatically analyzing and comparing information in one or more of the plurality of data points. In accordance with such data checking and cleansing activity, one or more automated background processes (e.g., “daemons”) calculate and report dates associated with retention and/or destruction policies.

### Generating and Maintaining an Audit Trail

In addition to capturing and managing documents and information, and to managing and enforcing rules associated with PD and DD retention, the present application includes functionality for generating and managing audit trails for compliance with one or more policy rules. Physical mail is processed to capture and manage its respective content and for enforcing retention policies, and an auditing module provides tracking functionality, including the monitoring of how, when and where users interact with the PD and/or DD (e.g., scanned) copy thereof.

In one or more implementations, a dynamic tagging module is part of or accessed by the auditing module, and is configured to generate a tag list containing information representing user events associated with a respective PD and/or DD. For example, the dynamic tagging module generates an entry and/or updates a tag list when a user accesses a scanned document, emails a scanned document, prints a DD, accesses a PD or destroys a DD. As a user interacts with PD and/or DD, the tagging module is configured to add a tag (e.g., information) to the tag list, thereby maintaining an up-to-date history of user activity associated with the PD. For example, the dynamic tagging module can update the tag list with a respective index value representing user activity. Using the information in the tag list, various forms of data analysis can be performed, such as to identify a plurality of documents (e.g., PD and/or DD) that a single individual interacted with, or to identify a percentage of documents (e.g., PD and/or DD) that are or are not in compliance with one or more policies (e.g., that are overdue for destruction).

Referring now to FIG. 7C, steps 770 are illustrated for generating and updating an audit trail associated with management of a PD and/or DD, in accordance with an example implementation. At step 772, the process starts and a DD (e.g., DRPD) is created, transformed and/or distributed into the enterprise mail gateway in step 774, such as shown and described above in connection with steps 704-710 (FIG. 7A). At step 776, the auditing module creates a new audit trail entry for the DD created in step 774. For example, the dynamic tagging module generates a new tag list that includes an identifier of the DD and a tag entry including an index value representing that the DD has been distributed in the gateway. For instance, the addressee to whom the DD is routed at step 710 can be part of the tag list. At step 778, a determination is made whether the PD is to be retained. Accessing the PD's retention policy is described above, in connection with step 758 (FIG. 7B). The determination at step 778 can be made based at least in part by comparing the scheduled date for destruction to the current date. If the PD is to be retained, then the process branches to step 780 and user activity associated with the DD and/or PD is monitored and detected. For example and in connection with the scanned file, such user action can include accessing, opening, reading, modifying and/or destroying the file. In connection with the physical file, detected user actions can include whether the document was accessed, read, modified and/or destroyed.

Continuing with reference to the flowchart in FIG. 7C, the audit trail is updated to reflect the detected user action (step 782). In one or more implementations, a database is maintained that includes codes that represent respective user activity, such as described above, and the tagging module adds a tag that includes a code that corresponds to the detected user action. As additional user activity is identified, the tagging module adds new entries and the tag list grows. In certain instances, actions taken by user may warrant that one or more messages be generated and/or sent to another user. For example, a user may be authorized to access a DD, but not to modify it. At step 784, a determination is made whether the action detected in step 780 warrants notifying another user. If so, then the process branches to step 785, and a message is generated and sent. Alternatively, the process branches to step 792 and ends.

If the determination in step 778—which can execute continuously as a background thread—is that the PD is no longer to be retained (i.e., it has reached the end of its retention period), then the process branches from step 778 to step 786, and a confirmation is made that the storage location (e.g., box) of document(s) including the PD has been destroyed. It is not always practical to store a set of PD which all have the same date and the same retention window, and, as a consequence, the present invention provides an automated solution for managing mixed batches of PD. The solution is that none is destroyed before the end of its respective period, yet all within a given set are retained in a common physical storage and scheduled for destruction on a certain date shortly after the retention period expires. As noted above, the PD is to be retained for no shorter than the longest document retention period associated with the plurality of other respective documents with which the PD is stored. Thereafter, the corresponding (transformed) electronic file is deleted in step 788 and the audit log is updated in step 790. Thereafter, the process ends in step 792.

Thus, the present application provides functionality for ensuring that content management and retention policies, including policies that may differ for physical copies and electronic copies, are enforced. The present application further provides for automatic tracking of user activity. Thus, the present application can monitor whether appropriate personnel have taken required actions in connection with a respective document, including with respect to the PD and ED retention policies.

### Implementation of Document Retention Policies

In many cases, rules associated with the destruction of a document are necessary for regulatory or other compliance associated with the document. In other cases, a rule can be defined to ensure that a minimum amount of time passes prior to destruction of a physical/electronic document. The present application provides for flexible handling and management of PD/DD in accordance with such conditions. For example, the present application can ensure proper management for a respective piece of mail, such as to ensure that the received physical copy is securely stored and retained for a minimum required amount of time, and a digital copy is securely stored and also retained for the same or different minimum required amount of time. Certain documents of a highly sensitive nature can be managed such that DD and/or PD are not made and distributed except under specific conditions. For example, a subscriber's eDoc reader used by a subscriber 160 (discussed below and in the aforementioned patent documents which have been incorporated by reference) can allow a user to view the contents of a document without being able to make a copy and/or forward a copy to someone else. Other rules can be implemented, such as to preclude forwarding of a document to anyone who is outside of a particular network, outside of an active directory or other access list. This can further ensure compliance with internal policy or external rules (e.g., regulatory rules).

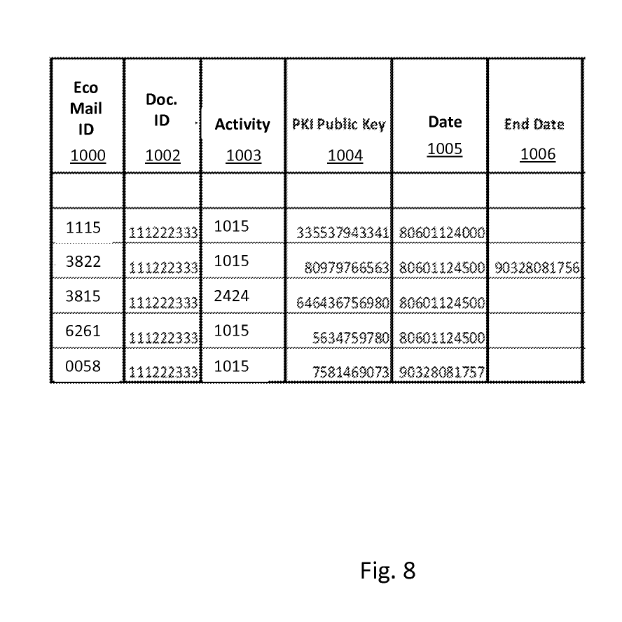

Moreover, one or more modules provide a graphical user interface that can include options for users to access various kinds of information associated with mail content. For example, and as shown in FIG. 8 a plurality of selectable documents are provided that correspond to a respective individual, identified by “Eco-Mail ID.” As a user selects one of the links corresponding to the documents (each of the data in the illustrated fields can comprise a link), the document and/or an audit trail associated with the document can be displayed. Various kinds of information, such as who interacted with the document (Doc. ID 1002), what activity was taken (1003), and other data such as whether the document is retained or destroyed can be conveniently displayed for the user or subsets can be displayed in accordance with any stored user-access privilege settings. In addition, functionality can be provided to enable a user to access one or more audit trails, for example to determine whether someone knew of a particular document 1002, someone reviewed the documents and/or someone complied with regulatory rules associated with the document.

For example, and in connection with a retention period for an electronic document, a 45 day period may define a minimum retention period for the electronic document. The present application includes functionality for monitoring the time period defined for document retention and internally checking audit trails for compliance with one or more policy rules. For example in the case of 45 day retention period, if it is determined by day 30 that the document had not been viewed or otherwise accessed by anyone, a message can be generated and/or transmitted, such as via email, text messaging or other suitable format, alerting a responsible party that the electronic document is queued for destruction within a few days. Message alerts can be transmitted with increasing frequency and can be formatted with urgency as the destruction date nears. In one or more implementations, one or more other parties, such as a supervisor, may be sent copies of the message in order to increase the likelihood that the document gets properly handled prior to its destruction.

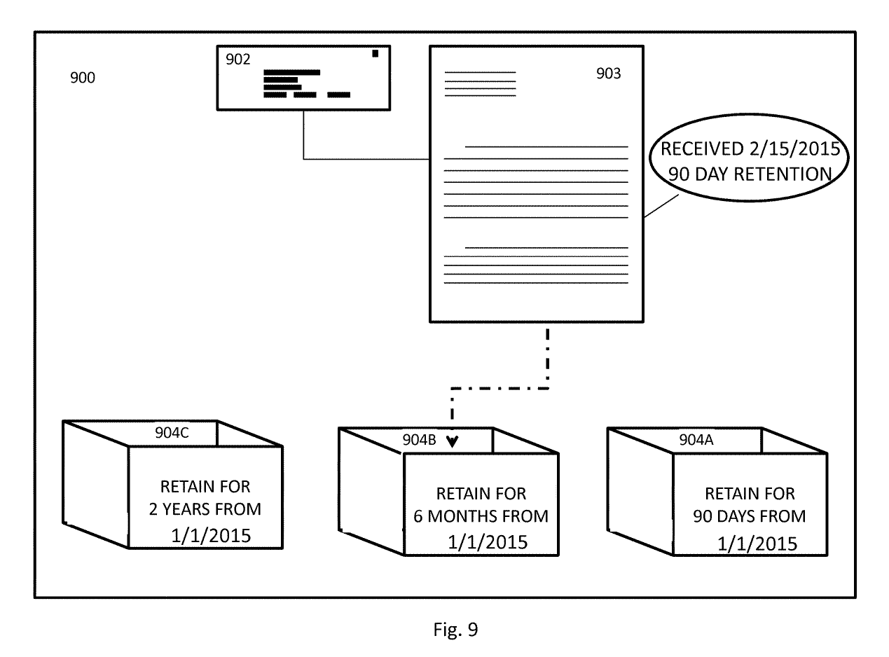

In addition to retention rules associated with DD, retention rules associated with PD can be automatically determined. FIG. 9 is a simple block diagram 900 illustrating an example implementation of the present application and representing document retention and storage of PD. For example, a piece of physical mail 902 is received and processed at mail triage station 112. The minimum retention date for the document that was received in the mail is 90 days from receipt. Included in FIG. 9 are three storage locations: 904A, 904B and 904C, each having a respective retention period (90 days, 6 months and 2 years starting from respective start dates). One skilled in the art will recognize that the implementation illustrated in FIG. 9 is for discussion purposes, and that many more storage locations, each having a respective retention period, can be used. Moreover, it is envisioned herein that in one or more implementations, a new storage location (e.g., box) could be used for every day that one or more documents are scanned. As noted, it is not generally practical to have boxes with retention start dates for each day of the year for each possible retention period, and so FIG. 9 provides an example as to how the system and method manage and coordinate physical and electronic copies of documents in regard to access, storage, retention, destruction and/or audit requirements.

Continuing with reference to the example shown in FIG. 9, also identified for each of the storage locations 904A-C is a starting date from which the respective retention periods run—1/1/15. Thus, documents stored in 904A are scheduled to be destroyed 90 days from 1/1/15, documents stored in 904B are scheduled to be destroyed 6 months from 1/1/15, and documents stored in 904C are scheduled to be destroyed 2 years from 1/1/15. The PD 903 shown in FIG. 9 was received on 2/15/2015 and has been identified as having a defined minimum retention period of 90 days. Accordingly, document 903 is directed to be placed in storage location 904B. Thus, as shown and described with respect to FIG. 9, documents are sorted into storage locations 904A-C that have retention dates scheduled for destroying the contents (e.g., letters and other documents). Information associated with retention dates associated with the respective storage locations can be managed by TMS 140, and a determination can be made substantially automatically to identify the appropriate location (e.g., one of 904A-C) and to instruct a user or robotic system to store the document accordingly. The PD stored in the respective storage locations 904A-904C can, therefore, be retained subject to no shorter than the longest period of time defined by the respective location.

Thus as shown and described with reference to FIGS. 7-9, the present application provides improved capture, management and retention of physical mail has been is received, for example, by a company. Retention locations and periods are linked to one or more respective datasets for implementing retention policies. Upon implementing a retention policy, both the PD and the electronic document are destroyed, while an audit trail identifying actions taken in connection with the PD/DD is preserved.

### Electronic Communications Network

Turning next to FIG. 1, a simplified view of an example electronic communications network 100 in accordance with an implementation of the present application is illustrated. The network can comprise both public and private segments. For instance, the network segments can include one or more of the following: the Internet, dedicated communications circuits, wide area networks or other types of communications networks. The network 100 is utilized to collect and distribute referential data that is used, in accordance with a salient aspect of the invention, in order to structure and control the flow of content and transactional records that contain the content that is to be distributed between entities and/or devices in accordance with the broad teachings of the present application. Associated with the communications network 100 is an Eco Mail (“EM”) system 102 that can include one or more machines that receive and process physical mail and/or electronic documents (“eDocs”), and that include eDoc transactions in support of eDoc delivery. The EM system 102 can be configured with various modules, including a processing and/or distribution gateway, such as shown and described in commonly assigned and co-pending patent application U.S. Ser. No. 14/530,511. Moreover, the EM system 102 can be configured with various components and with corresponding functionality, including as shown and described in commonly assigned and co-pending patent application U.S. Ser. No. 14/318,074.

More particularly and with continued reference to FIG. 1, users include physical document (“Doc”) Doc/eDoc Providers 110a-c, Financial Intermediaries 120a-b, eDoc Reference Data Station 130, eDoc Transaction Management Station 140, Email Providers 150a-b, and EM Subscribers 160a-d. Also, the EM system 102 including each of its modules, stations, and machines can further have data storage local to the machines that support its operations or the data can be stored in the cloud that includes the network 100. As can be appreciated, EM subscribers and other third parties can be the source of physical mail that is received and processed at a mail triage station 112.

Doc/eDoc Providers (hereinafter, “Providers”) 110a-c comprise (1) large commercial institutions who can alternatively interact directly with the electronic commercial mail distribution network (ECMDN), (2) moderate sized commercial institutions that may act through an intermediary document and/or eDoc Aggregator 115, to provide specific services related to providing, capturing and/or formatting content and connecting to the ECMDN, (3) small commercial entities that outsource content production and management to a third party that creates and maintains source content and can provide services to capture and/or format such content and connect and transmit the formatted content to the EMCDN, and (4) individuals such as EM subscribers corresponding with a company or another provider. In one or more alternative implementations, physical mail received directly or indirectly from Providers 110a, 110b and/or 110c is processed in accordance with the teachings herein.

The intermediary document and/or eDoc Aggregator 115 can comprise a third party that receives all or a portion of physical mail that is directed to persons or groups at a given Doc/eDoc provider, and manages the capture of content. For instance, the Aggregator 115 can be a facility that stores PD, now equipped with mail openers and document scanners to capture content as an electronic file and optionally format the captured content into a structured electronic file that can cooperate with the EM system 102 to implement its distribution, management, and auditing functionality.

Financial Intermediaries 120a-b comprise those financial institutions and financial service providers that provide financial management software and/or services to EM Subscribers 160a-d. In some implementations, instead of a financial intermediary, there could be a different service provider, such as a healthcare provider or an insurance service provider.

The eDoc Reference Data Station (“RDS”) 130 can be configured to include a centralized hub that can be accessed by one or more participants of the system. In one or more implementations, the RDS 130 can be and preferably is used for the purposes of: controlling registration as a member of the ECMDN, receiving data that uniquely identifies each participant, searching for other members of the network, and creating subscription relationships between and among members to facilitate, and control, and secure content communication and management and to establish and maintain alerting rules and delivery mechanisms.

The eDoc TMS 140 also can comprise a centralized hub having a processor and code executing therein which is operative to capture, format, validate, secure, transmit, and track all transactions within the embodied ECMDN. In one embodiment, code executes locally within a processor of the hub to provide this functionality.

The RDS 130 and the TMS 140 each can have communication facilities (e.g., a network interface card and respective communications modules) to support communications therebetween and with other nodes on the network 100, and/or to operate as a distribution gateway for distribution of content in the enterprise, that is, both the structured electronic file comprising the content captured from PD and DD (herein, collectively referred to as “content” unless the context requires more specificity). Stations 130, 140 communicate with each other, for example, in order to insure that a valid subscription exists for each requested eDoc Transaction, to identify subscriber routing, to identify copy and forward requirements and addresses for each transaction, and to determine the correct public encryption key for each transaction.

Email Providers 150a-b can be an Email Provider of any scale, but are envisioned as typically being a commercial Email Provider providing generalized email services to a broad audience. It should be understood, however, that Email Providers 150a-b can be entities that have a dedicated purpose of receiving, managing and forwarding ECMDN transactions.

EM Subscribers 160a-d are individuals or other entities who have registered with the EMCDN in order to receive and manage commercial content through the system of the present invention.

It should be understood that all communications among the participants that utilize the system can be performed in a conventional manner with existing protocols, such as HTTP or HTTPS or FTP, as a few non-limiting examples.

FIG. 2 is a functional block diagram of the ECMDN depicted in FIG. 1 showing interaction between and among its constituent components. As detailed in FIG. 2, communications take place through an electronic network, which may be private, public, or have both private and public paths. Providers 110a-c communicate directly or, through an eDoc aggregator 115, with the RDS 130 and the eDoc TMS 140, which can be included with or otherwise embodied in a mail “triage” station 112, described after a brief introduction to the participants of the system. As pertinent to the present invention, physical mail from any source can be bundled at a location 113 and provided to the triage station by conventional physical delivery.

The Providers identify themselves to the eDoc RDS 130 as members of the ECMDN and submit search requests and retrieve information about customers associated with them who are EM Subscribers 160a-d of the ECMDN. In addition, the Providers can retrieve templates and information about the data and formatting standards that are required for particular eDoc transactions.

In addition to physical mail sent from the Providers 110a-c, (communications by the Providers 110a-c with the TMS 140 are made in order to initiate and track eDoc transactions with EM Subscribers 160a-d who have previously been identified as customers and who have subscribed to receive communications in the form of eDocs from specific Providers 110a-c.

On the other hand, EM Subscribers 160a-d can communicate directly with the RDS 130 to provide information about themselves as members of the ECMDN, to search, identify and subscribe to receive eDoc communications from Providers 110a-c. EM Subscribers can also manage supplemental eDoc delivery of transactions that are addressed to them, including copying other subscribers on certain types of content and forwarding content to a subscriber who has assumed fiduciary responsibility for the forwarding subscriber.

Communications between EM Subscribers and the RDS 130 typically include at least one segment over a public network such as the Internet. Communications between Providers and the RDS 130 can be conducted the same way, or may transpire over a VPN or other private connection.

A Financial Intermediary 120 also can communicate directly with the RDS 130 in order to obtain and reconcile referential electronic payment delivery information that has been provided by the Providers 110a-c, as can other service providers, as noted above. Email Providers 150a-b communicate with the TMS 140 to receive, acknowledge, deliver and confirm eDoc transactions that are to be delivered to EM Subscribers 160a-d that are among the Provider's clients.

### Content Management Subscription, Distribution and Electronic Processing

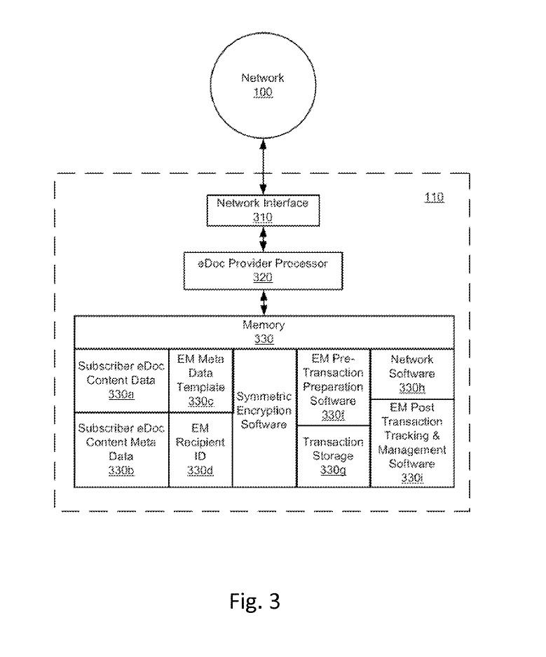

With reference now to FIG. 3, the major components of an eDoc Provider station 110 are illustrated and described in regard to the manner of conveyance of the content by the eDoc Provider, including the process of capturing as an electronic file, and formatting into a structured electronic file, the content from a document originally received at the mail triage station 112 or otherwise generated and converted to an eDoc, as the case may be. The station 110 can cooperate with the EM system 102 to implement its distribution, management, and auditing functionality.

A network interface card 310 connects the station 110 to the network 100 and supports bidirectional communications. A processor 320 and a memory 330 operate in support of a set of modules or code that is configured to provide the requisite functionality described hereinafter. As will be appreciated, the station 110 can comprise one or more computing machines and can be configured as a network server or servers. It should be appreciated as well that an embodiment of the invention can have certain functions performed by the eDoc Aggregator 115 rather than by the eDoc Provider station 110, and in that case the code or hardware can be included in that machine instead.

The memory 330 stores the source content of a Provider that is to be converted into an eDoc, which, from the foregoing discussion, is understood as sometimes being a scanned copy of a PD received at al mail triage station 112 or that otherwise has been scanned. The memory can have virtual or physical partitions, and source content can be stored, for example, in area 330a. Metadata concerning the source content can be stored in another partition, such as area 330b and used by the ECMDN to create a valid eDoc Transaction. The metadata specifications can vary based on many factors such as industry, industry sub-category, and document type. In part, the metadata includes subscriber eDoc Content Metadata such as Provider id, subscriber id, industry, industry sub-category, document type, customer account number, response required indicator, response required date, period start date, period end date, total amount due, and minimum amount due. The metadata can be an extensible format and vary as a function of document type, industry and other factors, as noted.

Each Provider ascertains the requirements for the source content conversion by communicating with the RDS 130 to identify and retrieve the appropriate EM Metadata Template. The template can be stored in another partition of the memory of the station 110, such as area 330c. The memory 330 also stores the EM Recipient's GUID, such as in area 330d. The EM Recipient GUID is ascertained from valid subscription relationships by communications between the eDoc Provider station 110 and the RDS 130.

The station 110 also can include code that is operative to manipulate the data in memory areas 330a-d so as to provide standardized formatting and eDoc security features before a transaction is sent to the ECMDN. The code can be stored within the station, such as within portions of the memory 330 (as illustrated), or within a storage device that is in communication with the station and is accessible to the processor 320. There are four core code-portions that are preferably implemented as software. The code can comprise one or more programs or libraries that, when executed, cause the station 110 to have the functionality described immediately above.

Additionally, the EM Pre-Transaction Software 330f can communicate with the TMS 140 in order to have the content formatted, validated, secured, transmitted, and tracked by the TMS 140 as it moves through the EM system. Another program code portion comprises Network Software 330h that handles communication of data to and from the network 100. Another program code portion comprises EM Post Transaction Tracking & Management Software 330i which validates that all transactions submitted to the ECMDN are properly processed, and which, upon determining that a transaction may not have been received or processed correctly by the ECMDN, re-initializes such transactions. A Transaction Storage area of the memory, such as area 330g, can be utilized to maintain a log of the transactions submitted to the ECMDN and their current state.

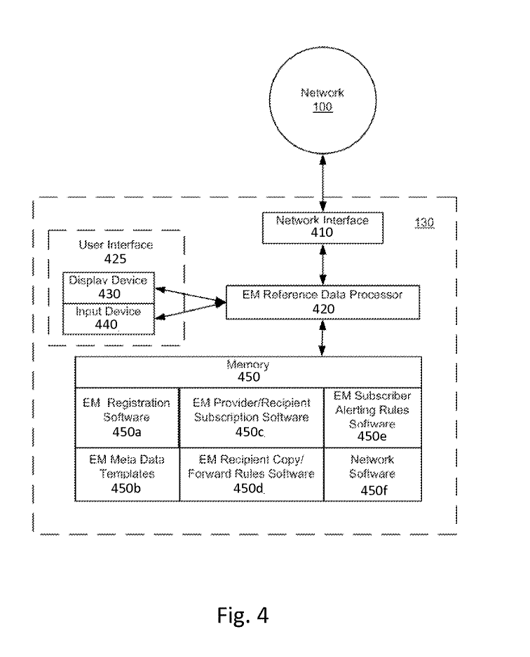

An example implementation of the Reference Data Station 130 is described next with regard to FIG. 4. The RDS 130 includes a NIC 410, processor 420 and memory 450, of the type as previously described. Of pertinence here, the RDS 130 also includes a user interface 425 that includes a presentation through a display device 430 and connectivity to an input device 440. In a preferred embodiment, the display device 430 is a monitor and the input device a keyboard, but the input/output devices can be implemented otherwise so long as data are conveyed in a recognizable form to and from a human being. Memory portion 450a stores EM Registration Software that is operative to allow new subscribers and Providers to register themselves with the ECMDN. This program portion collects meaningful data from the user to tie the user's ECMDN identity to physical locations where he or she receives or creates goods, services and/or paper documentation, and also ensures that registrants provide an email address that is within the domain of an Email Provider 150a-b that is a participant in the ECMDN so that eDoc transactions can be routed to the EM Subscriber once they are registered.

Registrants are also required by the EM Registration Software 450a to validate their identity. In one embodiment of the invention, validation can be accomplished by the registrants accessing the software via a trusted source. The trusted source can be a financial intermediary with whom the registrant has already established their identity. Validation can alternatively be achieved via testing against a third-party database. Thus, for example, validation can comprise correct responses to a series of queries posed through the user interface 425 against a known set of data about a registrant from a third-party database, such as a credit bureau.

Memory portion 450b contains a multitude of EM Metadata Templates that can be accessed by Providers 110a-d to insure that the proper metadata and format requirements for each specific type of eDoc transaction are met. Memory portion 450c can have the EM Provider/Recipient Subscription Software. This software allows EM Subscribers to establish and manage a set of subscriptions with various Providers from whom they are willing to accept eDocs. The subscription software further allows EM Subscribers to more granularly control what types of eDocs they are willing to accept and potentially with what frequency. Subscriptions can be generated by automated look-ups against an existing list of physical mail providers, by direct entry of an eDoc Provider GUID, by manual search or as an affirmative response to a proposed subscription by an eDoc Provider. In part, the software in memory portion 450c, the EM Provider/Recipient Subscription Software, can include a routine that performs such automated look-ups.

Memory portion 450d can have the EM Recipient Copy/Forward Rules Software. This software allows subscribers to create and manage relationships with other ECMDN subscribers for the purpose of sharing with or having other subscribers manage some or all of their eDoc transactions.

Memory area 450e contains EM Subscriber Alerting Methods & Rules Software which accepts information from subscribers in connection with how and when they would like to be notified of eDoc transactions that have required actions which need to be performed. This data is utilized by the EM TMS 140 to provide automated notifications and reminders. Such notifications are useful, including in connection with the present application's pre-electronic conveyance processing coupled with features associated with document auditing and retention implementation, such as shown and described herein. In this regard, a suitably configured interface includes can capture user alert preferences in relation to each Provider. This can be done in conjunction with the subscriber establishing a relationship with the Providers using the EM system 102, or at a later time. The interface captures data associated with the Provider, such as the number and frequency of any alerts, whether follow-up procedures should be used (e.g., automated phone calls and IVR processing), and the timing of the notifications. For instance, if a particular Provider requires payment 30 days from the transmission of an invoice, the subscriber can set an alert for that Provider of increasing urgency, starting, say, ten days before the due date with a change of the message to yellow, and then to red as the due date draws nearer coupled with a phone call to the subscriber to announce the impending deadline, etc. The appropriate action-required dates can be automatically derived from the “Action Required Indicator” and “Action Required Date” fields of the public metadata associated with any eDoc transaction of a content type having such a field, and a subscriber may be able to add preferred reminders and the like or otherwise modify or create an action-indicator. Memory 450 also contains Network Software in area 450f to handle communication of data to and from the network 100.

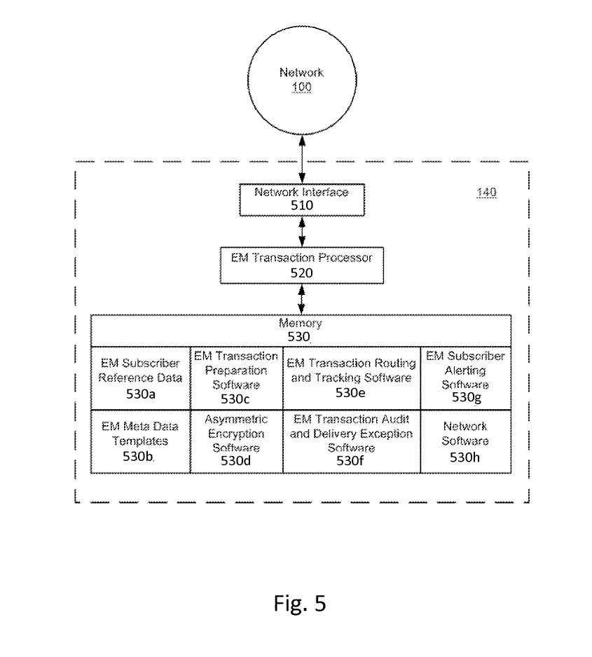

FIG. 5 depicts an example implementation of the eDoc TMS 140. The TMS 140 has a NIC 510, a processor 520 and a memory 530 as previously described. A memory portion 530a stores EM Subscriber Reference Data while memory portion 530b stores EM Metadata Templates. The templates, as described above, are communicated to the TMS 140 from the RDS 130. The EM Subscriber Reference Data is utilized by the EM Transaction Preparation Software stored in memory portion 530c to insure that, for each eDoc transaction, a valid subscription agreement exists between the eDoc Provider and the intended recipient. This data is further utilized, when a transaction has been validated, to determine what supplemental copies of the transaction are to be created, which public asymmetric encryption key is to be utilized to encrypt the eDoc transaction, and to assign the correct email address for forwarding each copy of the completed formatted and encrypted eDoc transaction. The EM Metadata Templates are also utilized by the EM Transaction Preparation Software 530c to validate that the necessary metadata and format requirements for each eDoc transaction have been met.

Memory portion 530d includes Asymmetric Encryption Software which is utilized to encrypt the symmetric encryption key that is used by the eDoc Provider to encrypt source content. Memory portion 530e includes EM Transaction Routing and Tracking Software which manages the delivery and state tracking of each eDoc transaction. In this regard, the software updates a database with information concerning the movement of each eDocument. For instance, after creation of a particular document, its being sent to an EM Subscriber, its being received by the EM Subscriber station, its being opened by the EM Subscriber, and its being processed in accordance with any associated metadata can all be tracked by the EM Transaction Routing and Tracking Software as a result of messages conveyed between the EM subscriber and the TMS 140. The EM Transaction Routing and Tracking Software can also track payment status provided b Financial Intermediaries 120 for specific eDocuments.

Memory portion 530f includes an EM Transaction Audit and Delivery Exception Software which monitors the delivery-state tracking of each eDoc transaction and determines when delivery exceptions exist which must be reported to the provider for remediation. The determination of delivery exceptions can be based on combinations of eDoc transaction state, document type, provider, the passage of time or another prescribed criterion or a combination of such criteria. This software communicates those exceptions to the eDoc provider 110a-c.

An EM Subscriber Alerting Software is in memory portion 530g which monitors the transaction state of each eDoc transaction based on the public attributes of each eDoc transaction and subscribes rules established by each EM Subscriber 160a-d. The software can control how and when a user is alerted that eDoc transactions exist that has yet to be taken appropriate action. When conditions exist that require alerting, this software program identifies the alternative methods of communication established by the EM Subscriber 160a-d and obtained from the EM Subscriber Reference Data in memory portion 530a and creates those communications. In one embodiment of the invention, a messaging module is provided that is configured to provide communications that can be in the form of email messages to one or more email addresses, text messages to communication devices and addresses so equipped, or text-to-voice messages to voice communication enabled devices. Memory 530 also contains Network Software in memory portion 530h to handle communication of data to and from the network 100.

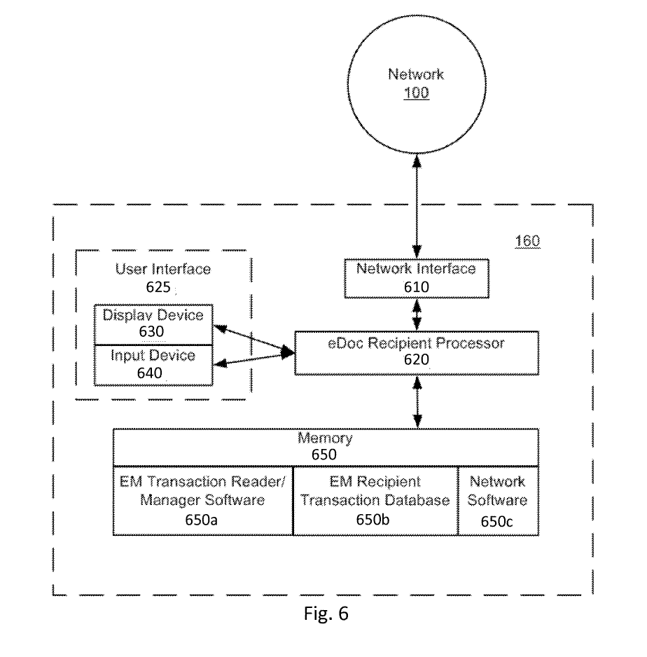

FIG. 6 illustrates certain components of the EM Subscriber station 160a-d that are relevant to the operation of the ECMDN; Including a NIC 610, a processor 620, a user interface 625, and a memory 650, such as described above. The user interface 625 is further comprised of a display device 630 and an input device 640 such as described above. Memory portion 650a includes EM Transaction Reader/Manager Software which is utilized to receive, validate, decrypt, display, manage and store eDoc transactions that have been sent to each eDoc Subscriber 160a-d. Memory portion 650b stores the EM Recipient Transaction Database, a repository of decrypted eDoc transactions and the metadata associated with each eDoc transaction. Finally, memory portion 650c has Network Software to handle communication of data to and from the network 100.

Thus and in accordance with one or more implementations of the present application supports a company or other organization having a plurality of business units, each having one or more respective business rules associated with document retention. DD retention rules associated with each of the respective business units can also be managed and enforced as a function of one or more modules associated with an audit trail and enforcement.

Embodiments of the invention also can allow financial intermediaries to search, identify, access and store the GUID and profile data of each registered provider. Provider profile data includes mailing address as well as account data to facilitate electronic payments. This functionality allows financial intermediaries to access data required to deliver payments to provider members of the network as instructed by subscribers who are customers of each financial intermediary. The utilization of standardized GUIDs in transactions initiated by providers insures that payments will be sent to the correct provider in the most expeditious manner possible. In this regard, the system 102 can allow financial intermediaries to send specialized messages so as to update transaction statuses and provide Providers and Subscribers with more comprehensive message management. For example, the financial intermediary can provide notification of completed payments to improve auditing and more detailed alerts for the benefit of the subscriber.

The present application includes computer hardware and software modules that interact to generate an electronic file, such as a scanned image of a paper and, thereafter, one or more processes act to transform the electronic file into a structured file that represents the paper and/or its contents. The structured file is coordinated with machines on different networks (see, for example, FIG. 2) and traceability is provided back to the physical paper (and any subsequent movement of the physical paper during a retention period of the paper. Moreover, one or more audit aspects associated with the physical paper and/or the structured file is further provided in an audit trail. After the physical paper and/or the structure file is destroyed, an audit trail associated the audit aspect(s) can be maintained.

While the invention has been described in connection with certain embodiments, it is defined by the claims that accompany this description and is not to be read as being restricted to any one embodiment thereof.

What is claimed:

1. A computer-implemented system for processing and implementing retention policies for physical and digital copies of content in accordance with compliance instructions, the system comprising:
at least one processor;
a determination module comprising code operative within the at least one processor to process an image file generated from the physical copy of the content to obtain and identify at least a category of the content, and further to obtain and identify respective minimum document retention periods for the physical copy of the content and the digital copy of the content, wherein the determination module is further operative to identify a location to retain the physical copy with a plurality of other respective documents that each have a respective document retention period, such that physical copy is scheduled to be retained for no shorter than the longest document retention period associated with the plurality of other respective documents; and
an auditing module comprising code module operative within the at least one processor to monitor action taken in connection with at least one of the physical copy of the content and the digital copy of the content, and to identify that the physical copy of the content and the digital copy are retained in accordance with the compliance instructions.

2. The computer-implemented system of claim 1, further comprising a messaging module comprising code operative within the at least one processor to generate and transmit a message associated with retention rules associated at least one of the physical copy and the digital copy.

3. The computer-implemented system of claim 2, wherein the messaging module is further operative to transmit a message to at least one person, wherein the message represents imminent destruction of at least one of the physical copy and the digital copy.

4. The computer-implemented system of claim 3, wherein the messaging module is operative to transmit the message representing imminent destruction based on the monitored action.

5. The computer-implemented system of claim 1, further comprising a tagging module comprising code operative within the at least one processor and in connection with the auditing module to tag activity taken in connection with at least one of the physical copy and the digital electronic copy.

6. The computer-implemented system of claim 5, wherein the activity represents user interaction with the physical copy, and represents at least one of accessing, reading, modifying and destroying the physical copy.

7. The computer-implemented system of claim 5, wherein the activity represents user interaction with the digital copy, and represents at least one of accessing, opening, reading, modifying and destroying the digital copy.

8. The computer-implemented system of claim 5, wherein the tagging module is operative to generate and manage a tag list that includes the tagged activity.

9. The computer-implemented system of claim 5, further comprising a logging module comprising code that creates a log of the activity across all documents.

10. The computer-implemented system of claim 1, wherein the physical copy of the content is received by postal delivery, and the determination module is further operative to obtain and identify at least one of a sender and recipient of the physical content.

11. The computer-implemented system of claim 1, wherein at least one of the respective document retention periods of the physical copy and the digital copy is established by the determination module based on regulatory compliance.

12. A computer-implemented method for processing and implementing retention policies for physical and digital copies of content in accordance with compliance instructions, the method comprising:
processing, by a determination module comprising code operative within at least one processor, an image file generated from the physical copy of the content to obtain and identify at least a category of the content, and further to obtain and identify respective minimum document retention periods for the physical copy of the content and the digital copy of the content, and further comprising identifying, by the determination module, a location to retain the physical copy with a plurality of other respective documents that each have a respective document retention period, such that physical copy is scheduled to be retained for no shorter than the longest document retention period associated with the plurality of other respective documents; and
monitoring, by an auditing module comprising code operative within the at least one processor, action taken in connection with at least one of the physical copy of the content and the digital copy of the content, and to identify that the physical copy of the content and the digital copy are retained in accordance with the compliance instructions.

13. The computer-implemented method of claim 12, further comprising generating and transmitting, by a messaging module comprising code operative within the at least one processor, a message associated with retention rules associated at least one of the physical copy and the digital copy.

14. The computer-implemented method of claim 13, wherein the message is transmitted by the messaging module to at least one person, wherein the message represents imminent destruction of at least one of the physical copy and the digital copy.

15. The computer-implemented method of claim 14, wherein the message is generated and transmitted based on the monitored action.

16. The computer-implemented method of claim 12, further comprising tagging, by a tagging module comprising code operative within the at least one processor and in connection with the auditing module, activity taken in connection with at least one of the physical copy and the digital copy.

17. The computer-implemented method of claim 16, wherein the activity represents user interaction with the physical copy, and represents at least one of accessing, reading, modifying and destroying the physical copy.

18. The computer-implemented method of claim 16, wherein the activity represents user interaction with the digital copy, and represents at least one of accessing, opening, reading, modifying and destroying the digital copy.

19. The computer-implemented method of claim 16, further comprising generating and managing, by the tagging module, a tag list that includes the tagged activity.

20. The computer-implemented method of claim 16, further comprising generating a log of the activity across all documents.

21. The computer-implemented method of claim 12, wherein the physical copy of the content is received by postal delivery, and further comprising obtaining and identifying, by the determination module, at least one of a sender and recipient of the physical content.

22. The computer-implemented method of claim 12, wherein at least one of the respective document retention periods of the physical copy and the digital copy is established by the determination module based on regulatory compliance.
